(19) United States
(12) Patent Application Publication
(10) Pub. No.: US 2022/0187891 A1
(43) Pub. Date: Jun. 16, 2022

(54) POWER CONVERSION SYSTEM

(71) Applicant: CHANNEL WELL TECHNOLOGY CO., LTD., Taoyuan City (TW)

(72) Inventor: YI-AN PAN, Taoyuan City (TW)

(21) Appl. No.: 17/118,633

(22) Filed: Dec. 11, 2020

(51) Int. Cl. G06F 1/28; H02M 7/04; H02M 7/00

(52) U.S. Cl. CPC G06F 1/28; H02M 7/003; H02M 7/04

(57) ABSTRACT

A power conversion system connects a power supply and a computer device. The power conversion system includes a first port, input circuit, rectification circuit, output circuit, control circuit and second port. The first port connects to the power supply to receive a standby voltage input signal. The input circuit connects to the first port and the rectification circuit. The output circuit connects to the rectification circuit and the second port. The control circuit connects to the first port and the input circuit. The second port outputs a standby voltage conversion signal to the computer device. The standby voltage input signal from the power supply is converted into a standby voltage conversion signal required for the computer device, thereby dispensing with the need to change the power supply, enhancing ease of use, and reducing user expenses.

### BACKGROUND OF THE INVENTION

### 1. Field of the Invention

The present disclosure relates to conversion systems, and in particular to a power conversion system.

### 2. Description of the Related Art

Owing to rapid development of computer devices, computer devices assist human beings in handling related tasks in workplaces, at schools, and in research. Each computer device has electronic components, such as motherboard, processor, memory, hard disk drive, network card, and graphics card. A power supply is mounted on each computer device to supply power to the aforesaid electronic components and thus enable the computer device to function.

At present, computer devices require ATX12V power supply. This power supply provides multiple voltage levels, such as +3.3V, +5V, +5 Vsb, +12V and −12V. However, owing to advancement in technology of electronic components of computer devices, the aforesaid power supply capable of providing multiple voltage levels is not only outdated but also detrimental to voltage conversion efficiency.

Moreover, in 2019, Intel published the latest ATX12VO design guide, which provides guidelines on how a power supply outputs one single voltage level with a view to overcoming a drawback of the prior art: the inconvenience brought about by coexistence of multiple voltage levels in a system. In addition, to comply with the ATX12VO design guide, plenty electronic components have their designs changed accordingly with a view to enhancing voltage conversion efficiency. The ATX12VO recommends that a power supply must output only +12V voltage, which includes +12V and standby voltage +12 Vsb, with the standby voltage +12 Vsb being constantly provided to a computer device whenever the power supply is connected to utility power and its power switch is ON to supply a start voltage under which the computer device starts.

Multiple voltage levels are currently still provided not only by most commercially-available power supplies but also by power supplies of existing computer devices, with a standby voltage of +5 Vsb too low to meet user needs. On the other hand, commercially-available ATX12VO-compliant power supplies have yet come into existence. In this regard, user needs have not yet been fully met. Therefore, a solution must be provided to enhance ease of use of existing power supplies.

### BRIEF SUMMARY OF THE INVENTION

An objective of the present disclosure is to provide a power conversion system connected between a computer device and an existing power supply. The power conversion system converts the outdated +5 Vsb voltage into the desirable +12 Vsb voltage, such that users can keep using any outdated power supplies and thus avoid an increase in user expenses otherwise incurred in changing the power supplies. Furthermore, the present disclosure enhances ease of use.

To achieve at least the above objective, the present disclosure provides a power conversion system, connected to a power supply and a computer device, the power conversion system comprising: a first port connected to the power supply to receive a standby voltage input signal; an input circuit connected to the first port; a rectification circuit connected to the input circuit; a control circuit connected between the first port, the input circuit, the rectification circuit and the output circuit; an output circuit connected to the rectification circuit to output the standby voltage conversion signal; and a second port connected to the output circuit to send the standby voltage conversion signal to the computer device.

In an embodiment, the power conversion system further comprises a voltage sampling circuit connected between the rectification circuit and the output circuit and connected to the control circuit.

In an embodiment, the power conversion system further comprises an auxiliary circuit connected to the first port and connected between the rectification circuit, the output circuit, the control circuit and the voltage sampling circuit.

In an embodiment, the input circuit comprises: a first capacitor comprising a first end and a second end, the first end of the first capacitor connects to the first port, the second end of the first capacitor is connected to the first port and grounded; a second capacitor comprising a first end and a second end, the first end of the second capacitor connects to the first end of the first capacitor and the first port, the second end of the second capacitor is connected to the second end of the first capacitor and the first port and grounded; a first inductor comprising a first end and a second end, the first end of the first inductor connects to the first port, the first end of the first capacitor and the first end of the second capacitor, and the second end of the first inductor connects to the rectification circuit and the control circuit.

In an embodiment, the rectification circuit comprises: a first diode comprising a first end and a second end, the first end of the first diode connects to the second end of the first inductor and the control circuit, the second end of the first diode connects to the output circuit, the control circuit, and the voltage sampling circuit; a first resistor comprising a first end and a second end, the first end of the first resistor connects to the second end of the first inductor and the control circuit; a third capacitor comprising a first end and a second end, the first end of the third capacitor connects to the second end of the first resistor, and the second end of the third capacitor connects to the second end of the first diode, the control circuit, the output circuit, the voltage sampling circuit and the auxiliary circuit.

In an embodiment, the output circuit comprises: a fourth capacitor comprising a first end and a second end, the first end of the fourth capacitor connects to the second end of the first diode, the second end of the third capacitor, the auxiliary circuit, the control circuit and the voltage sampling circuit; a second inductor comprising a first end and a second end, the first end of the second inductor connects to the first end of the fourth capacitor, the second end of the first diode, the second end of the third capacitor, the auxiliary circuit, the control circuit, the voltage sampling circuit, and the second end of the second inductor connects to the second port; a fifth capacitor comprising a first end and a second end, the first end of the fifth capacitor connects to the second end of the second inductor and the second port, and the second end of the fifth capacitor is connected to the second port and grounded.

In an embodiment, the control circuit comprises a second resistor, third resistor, fourth resistor, fifth resistor, sixth resistor, sixth capacitor, seventh capacitor, eighth capacitor, ninth capacitor, tenth capacitor and controller; the controller comprises a plurality of connection ends, including a first connection end and a second connection end which are connected together and connected to the first end of the second resistor, the second end of the first inductor, the first end of the first diode, and the first end of the first resistor, wherein the sixth capacitor has a first end being connected to the second end of the second resistor and has a second end being grounded, wherein the third connection end of the controller is connected to the first end of the seventh capacitor, and the second end of the seventh capacitor is grounded, wherein the fourth connection end of the controller is connected to the first end of the third resistor, and the second end of the third resistor is connected to the first port, wherein the controller includes a fifth connection end connected to the voltage sampling circuit, wherein the controller includes a sixth connection end connected to a first end of the fourth resistor and a first end of the eighth capacitor, wherein the ninth capacitor has a first end connected to a second end of the fourth resistor and has a second end connected to a second end of the eighth capacitor and grounded, wherein the controller includes a seventh connection end connected to a first end of the fifth resistor, wherein the tenth capacitor has a first end connected to a second end of the fifth resistor and has a second end connected to a first end of the sixth resistor and an eighth connection end of the controller, wherein a second end of the sixth resistor is connected to the first end of the second inductor, the first end of the fourth capacitor, the second end of the first diode, the second end of the third capacitor, the auxiliary circuit, and the voltage sampling circuit.

In an embodiment, the voltage sampling circuit comprises: a seventh resistor comprising a first end and a second end, wherein the first end of the seventh resistor is connected to the first end of the fourth capacitor, the second end of the first diode, the second end of the third capacitor, the auxiliary circuit, the second end of the sixth resistor, and the first end of the second inductor; and an eighth resistor comprising a first end and a second end, the first end being connected to the second end of the seventh resistor and the fifth connection end of the controller, and the second end being grounded, wherein the auxiliary circuit comprises a second diode, and the second diode comprises a first end and a second end, the first end being connected to the first port, and the second end being connected to the first end of the fourth capacitor, the second end of the first diode, the second end of the third capacitor, the second end of the sixth resistor, the first end of the seventh resistor, and the first end of the second inductor.

In an embodiment, the power conversion system further comprises a mask and a rigid circuit board; the first port, the input circuit, the rectification circuit, the output circuit, the second port, the control circuit, the voltage sampling circuit and the auxiliary circuit are disposed on the rigid circuit board, the mask enclosing the rigid circuit board, but allowing the first port and the second port to be exposed from the mask.

In an embodiment, the power conversion system further comprises a mask and a flexible circuit board, the mask enclosing the flexible circuit board, wherein the input circuit, the rectification circuit, the output circuit, the control circuit, the voltage sampling circuit and the auxiliary circuit are disposed on the flexible circuit board, wherein the first port is disposed on a side of the mask and electrically connected to the input circuit, the control circuit and the auxiliary circuit on the flexible circuit board, wherein the second port is disposed on an opposing side of the mask and electrically connected to the output circuit.

Therefore, the power conversion system performs power voltage boosting on the standby voltage input signal (+5 Vsb) provided by the power supply and outputs the standby voltage conversion signal (+12 Vsb) to the computer device.

In practice, users only need to mount the power conversion system on an old power supply and connect the power conversion system to the computer device in order to obtain the standby voltage conversion signal of +12 Vsb for usage. In addition, the users need not change the power supply and thus can reduce user expenses. Furthermore, the present disclosure enhances ease of use.

### BRIEF DESCRIPTION OF THE DRAWINGS

FIG. 1 is a block diagram of a power conversion system according to an embodiment of the present disclosure.

FIG. 2 is another block diagram of the power conversion system shown in FIG. 1 according to the present disclosure.

FIG. 3A is a schematic view of a first port of the power conversion system shown in FIG. 2 according to the present disclosure.

FIG. 3B is a schematic view of a second port of the power conversion system shown in FIG. 2 according to the present disclosure.

FIG. 4 is a circuit diagram of the power conversion system shown in FIG. 2 according to the present disclosure.

FIG. 5A is a schematic view of the power conversion system according to an embodiment of the present disclosure.

FIG. 5B is another schematic view of the power conversion system according to an embodiment of the present disclosure.

FIG. 5C is yet another schematic view of the power conversion system according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

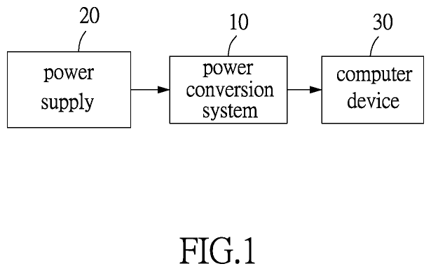

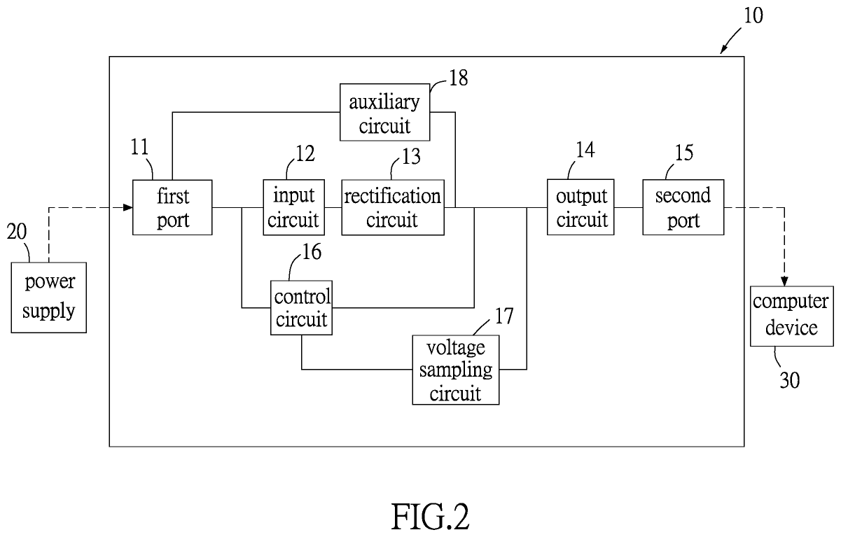

Referring to FIGS. 1, 2, a power conversion system 10 is provided according to an embodiment of the present disclosure. The power conversion system 10 connects a power supply 20 and a computer device 30. The computer device 30 is a desktop computer or a notebook computer.

In an embodiment, the power conversion system 10 comprises a first port 11, input circuit 12, rectification circuit 13, output circuit 14, second port 15, and control circuit 16.

The first port 11 is connected to the power supply 20 to receive a standby voltage input signal (+5 Vsb) from the power supply 20. The input circuit 12 is connected to the first port 11. The rectification circuit 13 is connected to the input circuit 12 and the output circuit 14. The second port 15 is connected to the output circuit 14 and the computer device 30. The control circuit 16 is connected between the first port 11, the input circuit 12, the rectification circuit 13 and the output circuit 14.

The power conversion system 10 further comprises a voltage sampling circuit 17. The voltage sampling circuit 17 is connected between the output circuit 14 and the rectification circuit 13 and connected to the control circuit 16.

The power conversion system 10 further comprises an auxiliary circuit 18. The auxiliary circuit 18 is connected to the first port 11 and connected between the rectification circuit 13, the output circuit 14, the control circuit 16 and the voltage sampling circuit 17.

The first port 11 is a 24-pin port or a port with a combination of 10 pins and 14 pins. Furthermore, the first port 11 is a male port or a female port. The way of combining the pins of the first port 11 is designed or adjusted as needed.

The second port 15 is a 10-pin port. Furthermore, the second port 15 is a male port or a female port. The pins of the second port 15 are designed or adjusted as needed, and thus the second port 15 is not necessarily the 10-pin port.

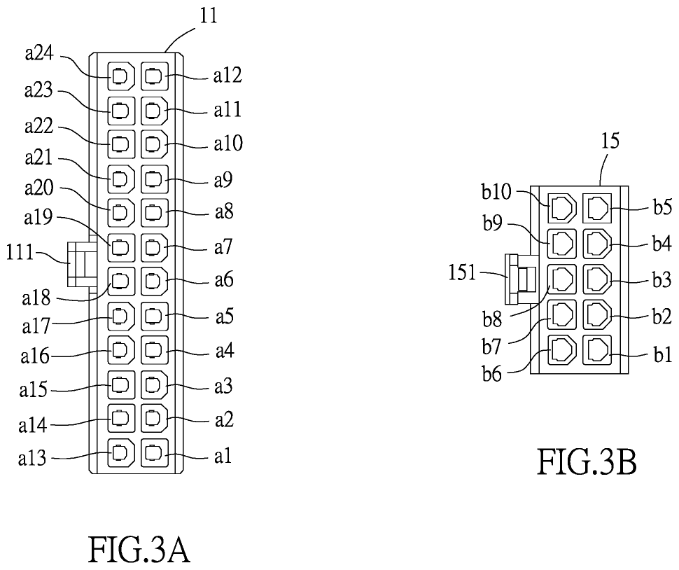

Referring to FIGS. 2, 3A, there are shown schematic views of the pins of the first port 11, which are exemplified by the standard 24 pins. The first port 11 comprises pins a1˜a24 and a first engaging portion 111. The first engaging portion 111 engages with a flexible cable (not shown) or the power supply 20 to enhance the connection. Respective connection functions of the pins of the first port 11 of the 24-pin port are described below. Pins a1, a2, a12, a13 are connected to the +3.3V pin of the power supply 20. Pins a3, a5, a7, a15, a17, a18, a19, a24 are connected to the ground pin of the power supply 20. Pins a4, a6, a21, a22, a23 are connected to the +5V pin of the power supply 20. Pin a8 is connected to the PG pin (power good pin) of the power supply 20. Pin a9 is connected to the +5 Vsb pin of the power supply 20. Pins a10, a11 are connected to the +12V pin of the power supply 20. Pin a14 is connected to the −12V pin of the power supply 20. Pin a16 is connected to the PS-ON pin (power supply on pin) of the power supply 20. Pin a20 is connected to the −5V pin of the power supply 20. The aforesaid connection functions of pins are defined for standard pins and thus are illustrative rather than restrictive of the present disclosure; thus, the aforesaid connection functions of pins can be designed or adjusted as needed.

Moreover, when the first port 11 is a port with a combination of 10 pins and 14 pins, not only can the connection functions of the pins be designed and connected as needed, but the received signals can also be converted by the power conversion system 10. Therefore, to achieve their respective connection functions, the pins of the aforesaid 24-pin structure can also be designed and connected as needed.

Referring to FIGS. 2, 3B, there are shown schematic views of the pins of the second port 15, which are exemplified by the standard 10 pins. The second port 15 comprises pins b1˜b10 and a second engaging portion 151. The second engaging portion 151 engages with a flexible cable (not shown) or the computer device 30 to enhance the connection. Respective connection functions of the pins of the second port 15 of the 10-pin port are described below. Pin b1 is connected to the PS-ON pin (power supply on pin) of the computer device 30. Pins b2, b3, b4 are connected to the ground pin of the computer device 30. Pin b5 is a (no connection, NC) pin. Pin b6 is connected to the PWR-OK pin (stable power supply digital signal pin) of the computer device 30. Pin b7 is connected to the +12 Vsb pin of the computer device 30. Pins b8, b9 are connected to the +12V pin of the computer device 30. Pin b10 is connected to the +12V pin of the computer device 30. The aforesaid connection functions of pins are defined for standard pins and thus are illustrative rather than restrictive of the present disclosure; thus, the aforesaid connection functions of pins can be designed or adjusted as needed.

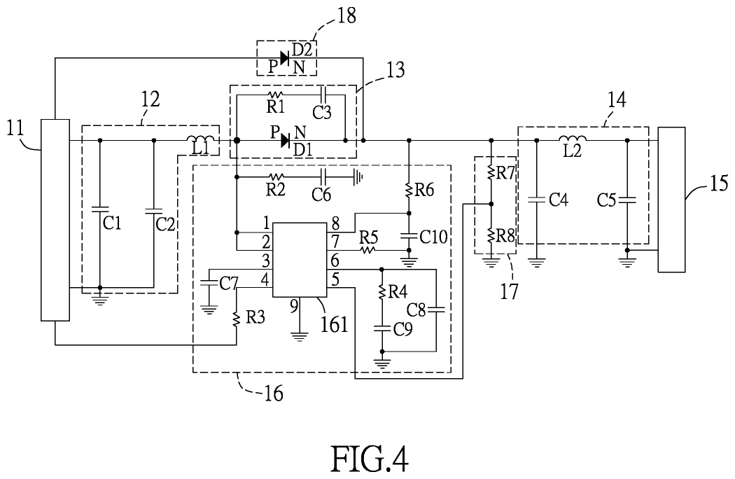

Referring to FIGS. 2, 4, there are shown circuit diagrams of the power conversion system 10. The input circuit 12 comprises first capacitor C1, second capacitor C2 and first inductor L1.

The first end of the first capacitor C1 connects to the first port 11. The second end of the first capacitor C1 is connected to the first port 11 and grounded.

The first end of the second capacitor C2 is connected to the first end of the first capacitor C1 and the first port 11. The second end of the second capacitor C2 is connected to the second end of the first capacitor C1 and the first port 11 and grounded.

The first end of the first inductor L1 is connected to the first end of the first capacitor C1, the first end of the second capacitor C2, and the first port 11. The second end of the first inductor L1 is connected to the rectification circuit 13.

The rectification circuit 13 comprises a first diode D1, a first resistor R1 and a third capacitor C3.

The first end (P) of the first diode D1 is connected to the second end of the second inductor L1 and the control circuit 16. The second end (N) of the first diode D1 is connected to the output circuit 14, the control circuit 16, and the voltage sampling circuit 17.

The first end of the first resistor R1 is connected to the first end (P) of the first diode D1, the second end of the first inductor L1, and the control circuit 16.

The first end of the third capacitor C3 is connected to the second end of the first resistor R1. The second end of the third capacitor C3 is connected to the second end (N) of the first diode D1, the output circuit 14, the voltage sampling circuit 17, and the auxiliary circuit 18.

The output circuit 14 comprises a fourth capacitor C4, a fifth capacitor C5, and a second inductor L2.

The first end of the fourth capacitor C4 is connected to the second end of the third capacitor C3, the second end (N) of the first diode D1, the control circuit 16 and the voltage sampling circuit 17. The second end of the fourth capacitor C4 is grounded.

The first end of the second inductor L2 is connected to the first end of the fourth capacitor C4, the second end of the third capacitor C3, the second end (N) of the first diode D1, the control circuit 16 and the voltage sampling circuit 17. The second end of the second inductor L2 is connected to the second port 15.

The first end of the fifth capacitor C5 is connected to the second end of the second inductor L2 and the second port 15. The second end of the fifth capacitor C5 is connected to the second port 15 and is grounded.

The control circuit 16 comprises a second resistor R2, third resistor R3, fourth resistor R4, fifth resistor R5, sixth resistor R6, sixth capacitor C6, seventh capacitor C7, eighth capacitor C8, ninth capacitor C9, tenth capacitor C10 and controller 161. The model number of the controller 161 is FP6296XR-G1, but the present disclosure is not limited thereto.

The controller 161 comprises a plurality of connection ends, including a first connection end 1 and a second connection end 2 which are connected together and connected to the first end of the second resistor R2, the second end of the first inductor L1, the first end (P) of the first diode D1, and the first end of the first resistor R1. The first end of the sixth capacitor C6 is connected to the second end of the second resistor R2. The second end of the sixth capacitor C6 is grounded.

The third connection end 3 of the controller 161 is connected to the first end of the seventh capacitor C7. The second end of the seventh capacitor C7 is grounded.

The fourth connection end 4 of the controller 161 is connected to the first end of the third resistor R3. The second end of the third resistor R3 is connected to the first port 11.

The fifth connection end of the controller 161 is connected to the voltage sampling circuit 17.

The sixth connection end of the controller 161 is connected to the first end of the fourth resistor R4 and the first end of the eighth capacitor C8. The first end of the ninth capacitor C9 is connected to the second end of the fourth resistor R4 and the second end of the eighth capacitor C8 and is grounded.

The seventh connection end 7 of the controller 161 is connected to the first end of the fifth resistor R5. The second end of the fifth resistor R5 is connected to the first end of the tenth capacitor C10. The second end of the tenth capacitor C10 is connected to the first end of the sixth resistor R6 and the eighth connection end 8 of the controller 161. The second end of the sixth resistor R6 is connected to the second end (N) of the first diode D1, the second end of the third capacitor C3, the first end of the fourth capacitor C4, the first end of the second inductor L2, the voltage sampling circuit 17, and the auxiliary circuit 18.

The ninth connection end 9 of the controller 161 is grounded.

The voltage sampling circuit 17 comprises a seventh resistor R7 and an eighth resistor R8. The first end of the seventh resistor R7 is connected to the second end of the sixth resistor R6, the second end (N) of the first diode D1, the second end of the third capacitor C3, the first end of the fourth capacitor C4, the first end of the second inductor L2, and the auxiliary circuit 18. The second end of the seventh resistor R7 is connected to the fifth connection end 5 of the controller 161 and the first end of the eighth resistor R8. The second end of the eighth resistor R8 is grounded.

The auxiliary circuit 18 comprises a second diode D2. The first end (P) of the second diode D2 connects to the first port 11. The second end (N) of the second diode D2 connects to the first end of the seventh resistor R7, the second end of the sixth resistor R6, the second end (N) of the first diode D1, the second end of the third capacitor C3, the first end of the fourth capacitor C4, and the first end of the second inductor L2.

In practice, the controller 161 receives the standby voltage input signal (+5 Vsb) provided by the power supply 20 through the first port 11 and the third resistor R3, so as to start and output control by switch control through the first connection end 1 and the second connection end 2, thereby controlling the operation of the power conversion system 10. The input circuit 12 receives the standby voltage input signal (+5 Vsb). The first capacitor C1 and the second capacitor C2 are charged to reduce noise and filtering waves, so as to stabilize the standby voltage input signal (+5 Vsb). Then, the first inductor L1 undergoes energy storage.

The rectification circuit 13 performs voltage rectification on the energy stored in the first inductor L1 to output the standby voltage conversion signal (+12 Vsb). The receipt of the standby voltage conversion signal (+12 Vsb) by the output circuit 14 causes the fourth capacitor C4 and the fifth capacitor C5 to undergo energy storage and the second inductor L2 to undergo wave filtration, so as to stabilize circuit operation and supply desirable power to the computer device 30 through the second port 15.

To stabilize the standby voltage conversion signal (+12 Vsb) thus output, the control circuit 16 obtains and processes a feedback voltage according to the voltage of the output circuit 14 through the voltage sampling circuit 17, generates a voltage control signal, and adjusts the duty cycle during which the controller 161 exercises switch control.

Moreover, to ensure current stability and circuit safety, the control circuit 16 obtains and processes a current sampling signal through the fifth resistor R5, the tenth capacitor C10 and the sixth resistor R6, generates a current control signal, and thus limits the current generated from the rectification circuit 13.

To ensure that the standby voltage conversion signal (+12 Vsb) thus output is stable and sufficient, the standby voltage input signal (+12V) is received through the auxiliary circuit 18 before undergoing rectification to provide an auxiliary voltage.

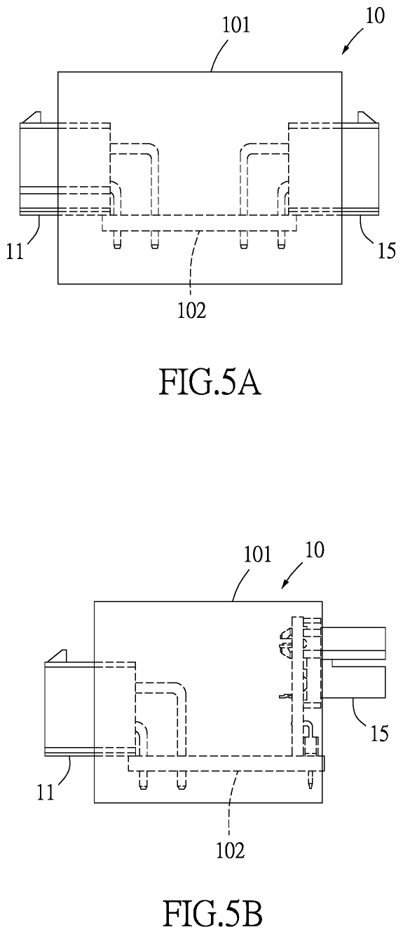

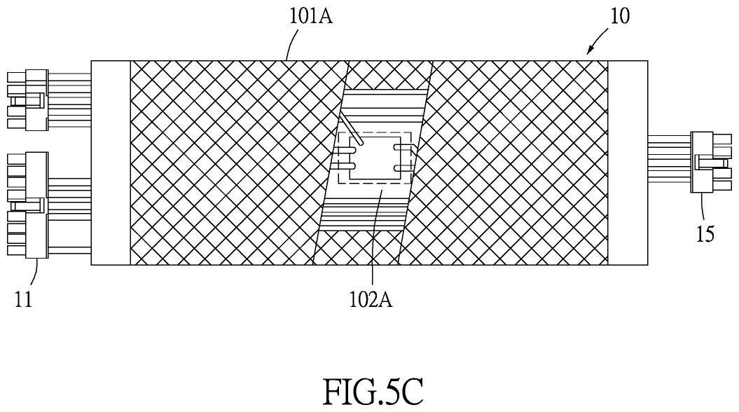

Referring to FIG. 5A, there is shown a schematic view of the power conversion system 10 according to an embodiment of the present disclosure. The power conversion system 10 has an adaptor card structure. The power conversion system 10 comprises a mask 101 and a rigid circuit board 102. The first port 11, the input circuit 12, the rectification circuit 13, the output circuit 14, the second port 15, the control circuit 16, the voltage sampling circuit 17 and the auxiliary circuit 18 are disposed on the rigid circuit board 102. The mask 101 is a rigid casing for enclosing and protecting the rigid circuit board 102 and protecting the circuit. The first port 11 and the second port 15 are exposed from the mask 101 to connect to the power supply 20 and the computer device 30.

Referring to FIG. 5A, to enable the power conversion system 10 with the adaptor card structure to be directly in use and thus achieve high-compatibility application, the first port 11 can be provided in the form of the aforesaid 24-pin port, and the first port 11 can be provided in the form of a female port. The second port 15 can be provided in the form of the aforesaid 10-pin port, and the second port 15 can be provided in the form of a female port. The first port 11 of the power conversion system 10 is connected to the power supply 20 by a flexible cable (not shown). The second port 15 is connected to the computer device 30 by another flexible cable (not shown).

Referring to FIG. 5B, there is shown another schematic view of the power conversion system 10 according to an embodiment of the present disclosure. The technical feature which distinguishes the power conversion system 10 of FIG. 5B from the power conversion system 10 of the FIG. 5A is described below. Referring to FIG. 5B, the second port 15 is a male port, such that the power conversion system 10 is connected to the computer device 30 through the second port 15; thus, it is not necessary for a flexible cable to be connected between the power conversion system 10 and the computer device 30.

Referring to FIG. 5C, there is shown yet another schematic view of the power conversion system 10 according to an embodiment of the present disclosure. The power conversion system 10 is provided in the form of a flexible cable and comprises a mask 101A and a flexible circuit board 102A. The input circuit 12, the rectification circuit 13, the output circuit 14, the control circuit 16, the voltage sampling circuit 17 and the auxiliary circuit 18 are disposed on the flexible circuit board 102A. The first port 11 is disposed on one side of the mask 101A and electrically connected to the auxiliary circuit 18, the control circuit 16, and the input circuit 12 on the flexible circuit board 102A through a plurality of circuits. The second port 15 is disposed on the other opposing side of the mask 101A and electrically connected to the output circuit 14 on the flexible circuit board 102A through a plurality of circuits. The mask 101A is a soft envelope for enclosing and protecting the flexible circuit board 102A and protecting the circuit. Both the first port 11 and the second port 15 are exposed from the mask 101A to connect to the power supply 20 and the computer device 30. Referring to FIG. 5C, the first port 11 can be provided in the form of the port with a combination of 10 pins and 14 pins, and the first port 11 can be provided in the form of a male port. The second port 15 can be provided in the form of the 10-pin port, and the second port 15 can be provided in the form of a male port.

Referring to FIG. 5C, the power conversion system 10 has the flexible cable structure, and the first port 11 is a port with a combination of 10 pins and 14 pins. Thus, even without being predefined, the connection functions of the pins of the first port 11 can enable the pins of the first port 11 to be directly connected to the power supply 20, and the received signals are converted by a circuit disposed on the flexible circuit board 102A. Referring to FIG. 5C, regardless of the connection functions of the pins, the first port 11 of the power conversion system 10 can be directly connected to the power supply 20 to enhance ease of use and flexibility of use.

While the present disclosure has been described by means of specific embodiments, numerous modifications and variations could be made thereto by those skilled in the art without departing from the scope and spirit of the present disclosure set forth in the claims.

What is claimed is:

1. A power conversion system, connected to a power supply and a computer device, the power conversion system comprising:
a first port connected to the power supply, so as to receive a standby voltage input signal;
an input circuit connected to the first port;
a rectification circuit connected to the input circuit;
a control circuit connected between the first port, the input circuit, the rectification circuit, and the output circuit;
an output circuit connected to the rectification circuit to output a standby voltage conversion signal; and
a second port connected to the output circuit to send the standby voltage conversion signal to the computer device.

2. The power conversion system of claim 1, further comprising a voltage sampling circuit connected between the rectification circuit and the output circuit and connected to the control circuit.

3. The power conversion system of claim 2, further comprising an auxiliary circuit connected to the first port and connected between the rectification circuit, the output circuit, the control circuit and the voltage sampling circuit.

4. The power conversion system of claim 3, wherein the input circuit comprises:
a first capacitor comprising a first end and a second end, the first end being connected to the first port, and the second end being connected to the first port and grounded;
a second capacitor comprising a first end and a second end, the first end being connected to the first end of the first capacitor and the first port, and the second end being connected to the second end of the first capacitor and the first port and grounded; and
a first inductor comprising a first end and a second end, the first end being connected to the first port, the first end of the first capacitor, and the first end of the second capacitor, and the second end being connected to the rectification circuit and the control circuit.

5. The power conversion system of claim 4, wherein the rectification circuit comprises:
a first diode comprising a first end and a second end, the first end being connected to the second end of the first inductor and the control circuit, and the second end being connected to the output circuit, the control circuit, and the voltage sampling circuit;
a first resistor comprising a first end and a second end, the first end being connected to the second end of the first inductor and the control circuit; and
a third capacitor comprising a first end and a second end, the first end being connected to the second end of the first resistor, and the second end being connected to the second end of the first diode, the control circuit, the output circuit, the voltage sampling circuit, and the auxiliary circuit.

6. The power conversion system of claim 5, wherein the output circuit comprises:
a fourth capacitor comprising a first end and a second end, the first end being connected to the second end of the first diode, the second end of the third capacitor, the auxiliary circuit, the control circuit, and the voltage sampling circuit;
a second inductor comprising a first end and a second end, the second end being connected to the second port, and the first end being connected to the first end of the fourth capacitor, the second end of the first diode, the second end of the third capacitor, the auxiliary circuit, the control circuit, and the voltage sampling circuit; and
a fifth capacitor comprising a first end and a second end, the first end being connected to the second end of the second inductor and the second port, and the second end being connected to the second port and grounded.

7. The power conversion system of claim 6, wherein the control circuit comprises a second resistor, a third resistor, a fourth resistor, a fifth resistor, a sixth resistor, a sixth capacitor, a seventh capacitor, an eighth capacitor, a ninth capacitor, a tenth capacitor and a controller,
wherein the controller comprises a plurality of connection ends, including a first connection end and a second connection end which are connected together and connected to a first end of the second resistor, the second end of the first inductor, the first end of the first diode, and the first end of the first resistor, wherein the sixth capacitor has a first end being connected to a second end of the second resistor and has a second end being grounded,
wherein the controller includes a third connection end connected to a first end of the seventh capacitor, and a second end of the seventh capacitor is grounded,
wherein the controller includes a fourth connection end connected to a first end of the third resistor, and a second end of the third resistor is connected to the first port,
wherein the controller includes a fifth connection end connected to the voltage sampling circuit,
wherein the controller includes a sixth connection end connected to a first end of the fourth resistor and a first end of the eighth capacitor, wherein the ninth capacitor has a first end connected to a second end of the fourth resistor and has a second end connected to a second end of the eighth capacitor and grounded,
wherein the controller includes a seventh connection end connected to a first end of the fifth resistor, wherein the tenth capacitor has a first end connected to a second end of the fifth resistor and has a second end connected to a first end of the sixth resistor and an eighth connection end of the controller, wherein a second end of the sixth resistor is connected to the first end of the second inductor, the first end of the fourth capacitor, the second end of the first diode, the second end of the third capacitor, the auxiliary circuit, and the voltage sampling circuit.

8. The power conversion system of claim 7, wherein the voltage sampling circuit comprises:
a seventh resistor comprising a first end and a second end, wherein the first end of the seventh resistor is connected to the first end of the fourth capacitor, the second end of the first diode, the second end of the third capacitor, the auxiliary circuit, the second end of the sixth resistor, and the first end of the second inductor; and
an eighth resistor comprising a first end and a second end, the first end being connected to the second end of the seventh resistor and the fifth connection end of the controller, and the second end being grounded,
wherein the auxiliary circuit comprises a second diode, and the second diode comprises a first end and a second end, the first end being connected to the first port, and the second end being connected to the first end of the fourth capacitor, the second end of the first diode, the second end of the third capacitor, the second end of the sixth resistor, the first end of the seventh resistor, and the first end of the second inductor.

9. The power conversion system of claim 3, further comprising a mask and a rigid circuit board, wherein the first port, the input circuit, the rectification circuit, the output circuit, the second port, the control circuit, the voltage sampling circuit and the auxiliary circuit are disposed on the rigid circuit board, wherein the mask encloses the rigid circuit board, but allowing the first port and the second port to be exposed from the mask.

10. The power conversion system of claim 3, further comprising a mask and a flexible circuit board, the mask enclosing the flexible circuit board, wherein the input circuit, the rectification circuit, the output circuit, the control circuit, the voltage sampling circuit and the auxiliary circuit are disposed on the flexible circuit board, wherein the first port is disposed on a side of the mask and electrically connected to the input circuit, the control circuit and the auxiliary circuit on the flexible circuit board, wherein the second port is disposed on an opposing side of the mask and electrically connected to the output circuit.
